(19) United States
(12) Patent Application Publication
(10) Pub. No.: US 2016/0281884 A1
(43) Pub. Date: Sep. 29, 2016

(54) INSERT BLOCK HALF

(71) Applicant: MCT BRATTBERG AB, Karlskrona (SE)

(72) Inventors: Bengt Johansson, Karlskrona (SE); Bo Birgerud, Höllviken (SE)

(73) Assignee: MCT Brattberg AB, Karlskrona (SE)

(21) Appl. No.: 15/031,451

(22) PCT Filed: Oct. 31, 2013
(86) PCT No.: PCT/SE2013/051275

§ 371 Date: Apr. 22, 2016

(51) Int. Cl. F16L 5/14; F16L 5/10; H02G 3/22

(52) U.S. Cl. CPC F16L 5/14; H02G 3/22; F16L 5/10

(57) ABSTRACT

An insert block half for sealing around a cable, pipe or wire. The insert block half comprises: a body with a first and a second end a first side intended to be arranged towards an substantially identical insert block half, and a semi-circular groove arranged in said first side and extending between the first and second end; and a number of a peelable layers arranged in the groove, each layer having a shape corresponding to the semi-cylindrical groove to fit within the groove and an length exceeding the length between the first and second end of the body.

### FIELD OF THE INVENTION

The present invention relates to an insert block half for sealing around a cable, wire or pipe.

### BACKGROUND OF THE INVENTION

Within many different technical fields, like for example merchant ships, offshore platforms and buildings with content of high importance there are several safety aspects that must be considered to avoid severe damages to the content within the structure as well as peoples working in or close to the area in case of accidents like for example fire or leaking water from the outside or within the platform, ship or building.

In case of explosion, fire or leaking water the fire and/or leaking water are often spread along wires, cables or pipes and in order to stop, or at least delay, the fire or water from spreading each cable, wire or pipe is sealed where they are lead through partition walls within the platform, ship or building.

One frequently used solution for providing a reliable sealing of cables, wires or pipes extending through partition walls involves a metal frame permanently installed in the wall to provide a passage of a predetermined size for the cables, wires or pipes in the desired area of the wall. The cables, wires or pipes are during installation lead through the frame. The space within the frame is during installation of the sealing filled with insert blocks packed in layers within the frame to completely fill the space within the frame. Each insert block consist of two block halves each provided with a semi-circular groove in one side of the block half such that a circular passage is generated through the insert block when the two block halves are put together. Each cable, wire or pipe extending through the frame is fitted in an insert block and packed within the frame. The outside dimension of the insert blocks is selected so that a predetermined number of insert blocks have a size corresponding to the space within the frame. After the blocks are packed side by side in layers in the intended position a pressure applying device is arranged in the top part of the frame. The pressure applying device, upon activation, applies a pressure on the blocks to press the blocks together and provide the desired sealing around the cables, wires or pipes within the frame.

However, in order to achieve the desired sealing the diameter of the passage in the insert block must correspond to the diameter of the cable, wire or pipe. The desired tight fitting is either achieved by using a number of insert blocks with different diameters of the passage or by an insert block with a larger passage and a number of peelable layers arranged in the groove such that a selected number of layers could be removed and the diameter of the passage adapted to each of the different cables, wires or pipes extending through the frame. The need for insert blocks of different sizes is thereby reduced considerably.

Different examples of insert blocks with removable layers are for example disclosed in WO2010/090588. The disclosed embodiments either comprises lugs extending from the edge of the different layer or cut out portions formed in the layer in order to make it possible to display layer marking that indicates the size of the opening of the insert block and facilitate the removal of the correct number of layers during installation.

Unfortunately the disclosed embodiments of insert blocks all have some severe drawbacks. First, manufacturing of insert blocks with a number of layers each having different lugs and/or cut out portions provided with individual marking is extremely expensive due to the high number of production steps involved for each layer, as well as the steps for arranging the different layers in the intended position in the insert block to finalize the insert block. Second, during installation it is difficult for the installation engineer to grip the correct layer or tiny lug, particularly if the layers are thin and/or the insert block small.

There is consequently a need for an improved insert block that facilitates the installation for the installation engineer and reduces the drawbacks described above.

### SUMMARY OF THE INVENTION

The present invention, defined in the appended claims, relates to a inset block half, an insert block and the use of an insert block for sealing a cable, pipe or wire extending through a partition wall.

The insert block half according to the invention comprises:
a body with a first and a second end, a first side intended to be arranged towards an substantially identical insert block half, and a semi-circular groove arranged in said first side and extending between the first and second end; and
a number of a peelable layers arranged in the groove, each layer having a shape corresponding to the semi-cylindrical groove to fit within the recess and an length exceeding the length between the first and second end of the body.

The insert block according to the invention solves, or at least reduce, the problems defined above since all layers have a straight continuous shape with an extended length which eliminates the need for expensive tooling to make it possible to cast each size of layer with its lug or tab individually, alternatively provide the cut out portions in the layers in order to provide visual marking of the layers. Each layer has the same shape (width) along the entire length of the layer which reduces the manufacturing costs considerably since the insert block half and the layers could be produced with more efficient methods.

The extended length furthermore facilitates for the installation engineer to grip the predetermined number of layers and peal them from the stack of layers in the groove of insert block half to adapt the radius of the passage through the insert block to different cables, wires or pipes.

As an additional advantage with the insert block half defined above the insulation and sealing properties of the insert block are improved since the remaining layers in the groove will enclose a longer section of the cable, wire or pipe and reduce the temperature within the cable, pipe or wire on the other side of the insert block, i.e. the other side of the partition wall.

In one embodiment of the insert block half, the layers adhere to adjacent layer, or groove, at least partially in the area between the first and second end of insert block half, and not adhere to each other i the area extending outside the groove of the insert block half. This embodiment facilitates the removal of the intended layers considerably since the free extending end of the layer could be griped more easily.

In one embodiment of the insert block half, the adhering is achieved by a coating applied between the layers or groove in at least a part of the area of the groove to achieve the desired adhering between the layers and the groove.

In one embodiment of the insert block half, numerical values or symbols corresponding to the radius of the passage formed by each layer are arranged on the part of the layers arranged outside the body where they are easy for the installation engineer to se.

In one embodiment of the insert block half, adjacent layers in the groove of the body have different colours in order to make it easy for the operator to see the different layers and facilitate future inspection of the installation since the different layers are easy to identify.

In one embodiment of the insert block half, the layers in the groove have substantially the same length and extend 5 to 30 mm outside the respective first and/or second end of the body in order to provide a good grip for the fingers of the installation engineer and provide the additional insulation around the cable, wire or pipe.

In one embodiment of the insert block half, at least some of the layers in the groove have different length. Different length further facilitates the identification and selection of the desired layers since the outer end of the layers will be more clearly displayed.

In one embodiment of the insert block half, the length of the layers are changed stepwise such that at least two adjacent layer have the same length.

In one embodiment of the insert block half, the layer adjacent to the groove in the body is the shortest one and the length of the layers increased towards the top layer of the insert block half. This embodiment is favourable since the layers arranged adjacent to the cable, wire or pipe is the one extending furthest from the end of the body and provide a very good sealing and insulation around the cable, wire or pipe as well as being very easy for the installation engineer to grip.

In one embodiment of the insert block half, the layer adjacent to the groove in the body is the longest one and the length of the layers decreased towards the top layer of the insert block half.

The invention furthermore relates to an insert block for sealing around a cable, pipe or wire comprising two insert block halves according to anyone of the embodiments described above arranged with the groove of respective insert half facing each other such that a passage for the cable, wire or pipe is formed through the insert block, and the use of a number of insert blocks in a metal frame fitted in a partition wall for sealing of at least one cable, pipe or wire extending through said partition wall.

The different embodiment described above could of course be combined and modified in different ways without departing from the scope of the invention that will be described more in detail in the detailed description.

### BRIEF DESCRIPTION OF THE DRAWINGS

Different embodiments of the insert block half according to the invention are illustrated in the appended figures.

FIG. 1 illustrates at perspective view of a sealing system.

FIG. 2 illustrates an exploded perspective view of a first embodiment of an insert block half.

FIG. 3 illustrates the insert block in FIG. 2 assembled.

FIG. 4 illustrates a perspective view of selected parts of a second embodiment of an insert block half.

FIG. 5 illustrates a perspective view of a third embodiment of an insert block half.

FIG. 6 illustrates a perspective view of a fourth embodiment of an insert block half.

FIG. 7 illustrates a perspective view of a fifth embodiment of an insert block half.

### DETAILED DESCRIPTION

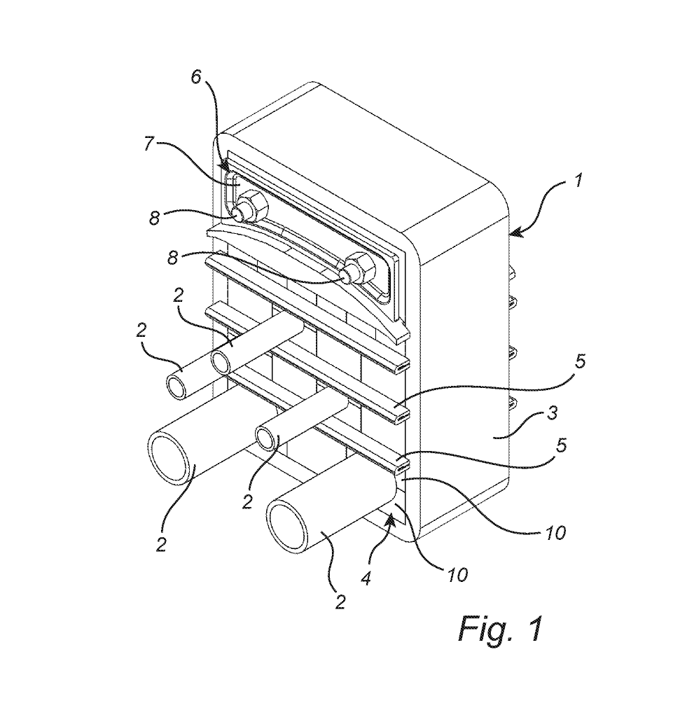

In FIG. 1 a sealing system 1 for sealing of cables 2, wires or pipes extending through a not illustrated partition wall. The system involves a metal frame 3 intended to be permanently installed in the partition wall to provide a passage of a predetermined size in the partition wall for the cables, wires or pipes extending through the partition wall. The cables, wires or pipes that need to pass through the partition wall are during installation arranged together and lead through the frame. During sealing of the frame an insert block 4, comprising two substantially identical insert block halves 10, is fitted around each of the cables, wires or pipes. The insert blocks, and the cable, wire or pipe extending through the insert block, are packed in layers within the frame to completely fill the space within the frame. The outside dimensions of the insert blocks are selected so that a predetermined number of insert blocks have a size corresponding to the space within the frame to fill the space within the frame and provide the desired sealing of the passage in the partition wall. The layers of insert blocks are separated by a guiding metal plate 5 in order to ensure that the layers remain in the intended position within the frame 3. If the number of cables, wires or pipes is less than the number of insert blocks within the frame, the insert blocks could be replaced by a solid elastic rectangular block to fill the remaining spaces within the frame.

After the blocks are packed side by side in layers in the intended position a pressure applying device 6 is arranged in the top part of the frame. The pressure applying device comprises a plate 7 arranged on each side of an elastic member and threaded shafts 8 extending through the elastic member. When the elastic member is compressed between the plates by the shafts and nuts arranged on the shaft the elastic element expand such that a pressure is applied on the layer packed within the frame 3 thereby eliminating gaps between the insert blocks and sealing the space within the frame. Different types of pressure applying devices are available and the described device could be replaced by anyone of the available devices.

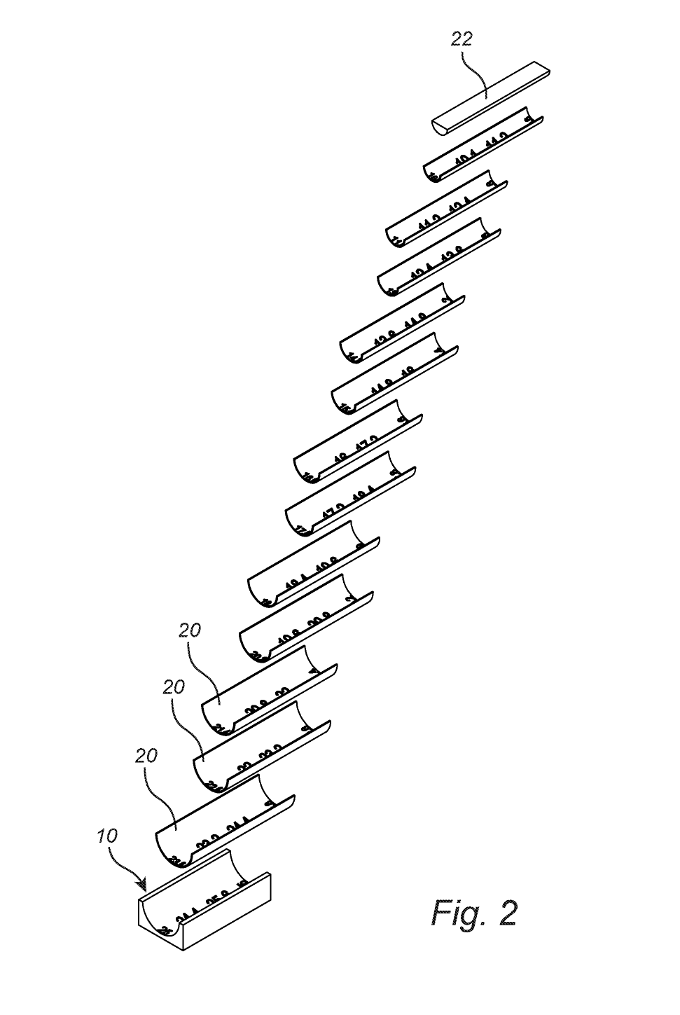

Each insert block consists of two insert block halves 10. Different embodiments of insert block halves are illustrated in FIGS. 2 to 7. All the illustrated insert block halves comprise a rectangular body 11. The body has a first end 12 and a second end 13 arranged on opposite side of the rectangular body. In one of the substantially flat sides 14, extending from the first to the second end, a semi-cylindrical groove 15 is formed in the body such that a circular passage is generated through the insert block when two identical block halves are put together with the grooves of each half facing each other.

The longitudinal central axis L of the semi-cylindrical groove is arranged parallel to the flat side 14 of the body as well as coaxial with a longitudinal central axis of the insert block formed of two identical insert block halves. The diameter of the semi-cylindrical groove is smaller than the width of the body so that an elongated contact surface 16 is formed along each side of the groove. The contact surfaces 16 of two adjacent insert block halves will be in contact with each other and thereby enclose the layers and the cable, wire or pipe arranged in the groove.

The body 11 is made of a pressure, water and heat resistant elastic rubber material adapted to the specific demands on this type of sealing devices. The dimensions of the insert block half are preferably selected so that the insert block will have a square cross sectional shape but other shapes could be used as long at the size of the insert block corresponds to the dimensions of the frame in the partition wall. For example, insert blocks with a circular cross section could be used in a circular partition wall frame.

In the semi-circular groove 15 a number of peelable layers 20 are arranged. Each layer is made of a pressure, water and heat resistant elastic rubber material adapted to the specific demands on the sealing devices and has a curved shape. The size and radius of each layer is adapted to the intended position within the stack of layers in the groove, i.e. the radius of layers arranged closer to the groove in the body are larger than for layers closer to the centre of the groove. Furthermore the width of the layers are adapted accordingly to form substantially flat surfaces 21 along the contact surfaces 16 of the body so that the cable, wire or pipe is enclosed by the layers remaining in the groove and the body of the insert halves fitted around the cable, wire or pipe. In the remaining passage, on top of the layer with the smallest radius and size a half-cylindrical solid sealing device 22 is arranged to close the passage through the insert block until the desired number of layers are removed during fitting of the insert block around the cable, wire or pipe.

The peelable layers 20 in the embodiment in FIG. 2 have substantially the same length exceeding the longitudinal length of the body, i.e. the distance from the first to the second end of the body, such that the layers extend outside the end surfaces of the body. In the illustrated insert block half the layers extend substantially the same distance outside the first and second end of the body but the layers could also be arranged to only extend outside the body in one direction. The layers preferably extend between 5 to 30 mm from the end of the body to make it possible for the installation engineer to grip the layer, or layers that should be removed to adapt the diameter of the groove in the insert half to the specific cable, wire or pipe diameter and ensure the desired sealing around the outer periphery of the cable, wire or pipe.

Layers 20 with the extended length described above will also provide additional insulation to the cable, wire or pipe in case of fire since the layers will enclose the cable, wire or pipe and thereby reduce the temperature in the section of the cable, wire or pipe located closer to the centre of the insert block halves.

In an alternative embodiment, illustrated in FIG. 4, the layers 40, all with a substantially constant length exceeding the longitudinal length of the body, are arranged such that every second layer extend from one end of the body 11 while the other layers extend in the opposite direction from the opposite end of the block to keep the extending part of the layers separated from each other and facilitate the gripping and removal of the layers during installation.

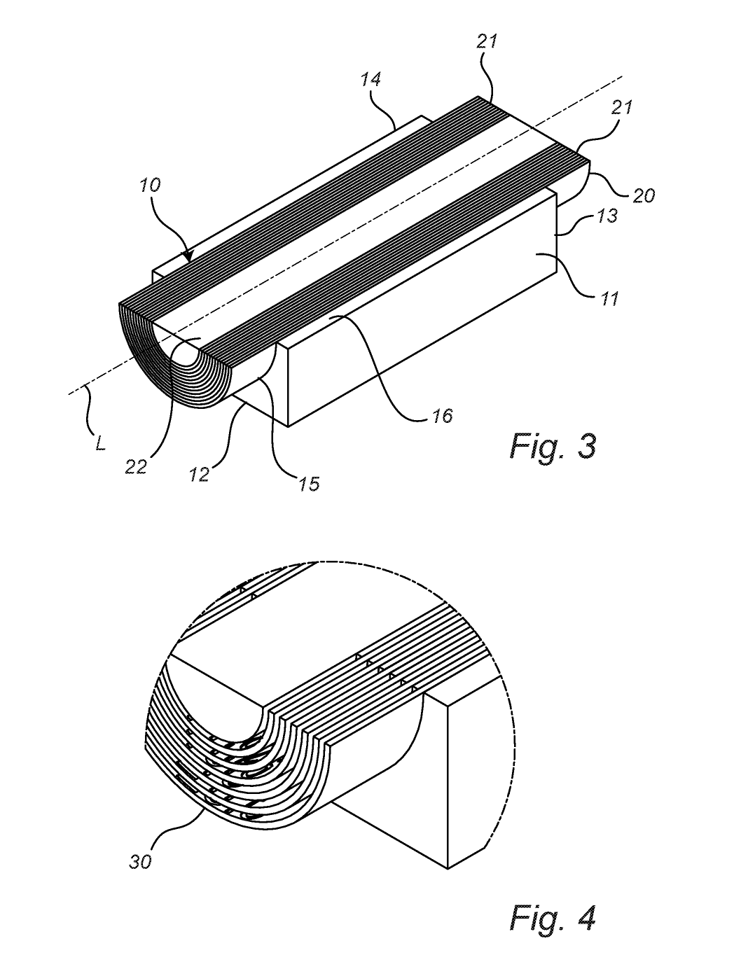

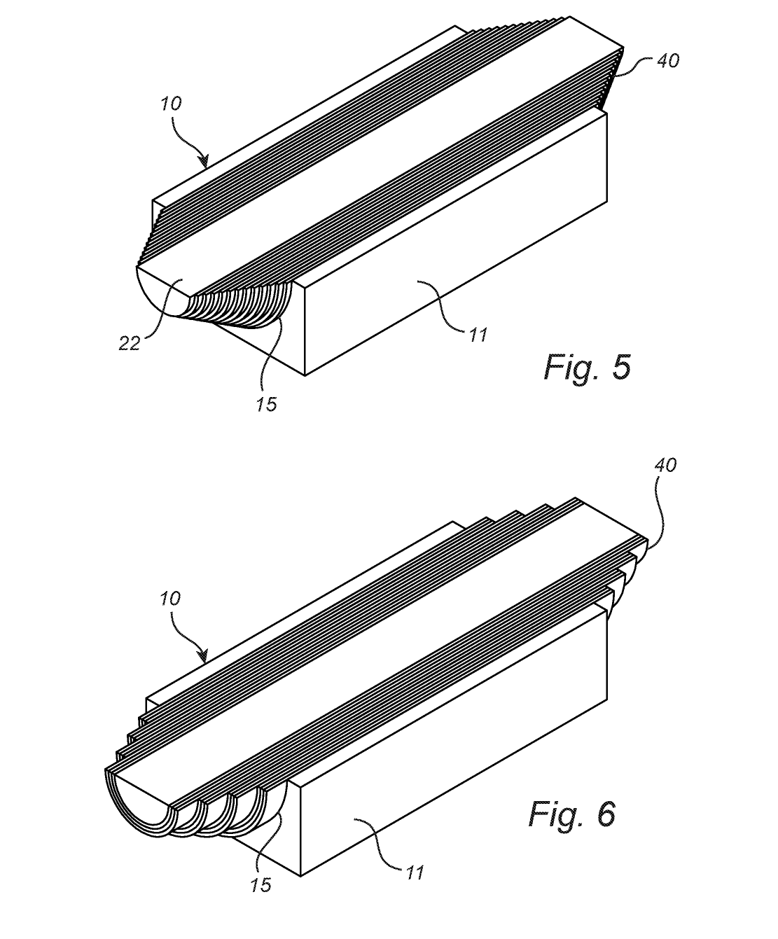

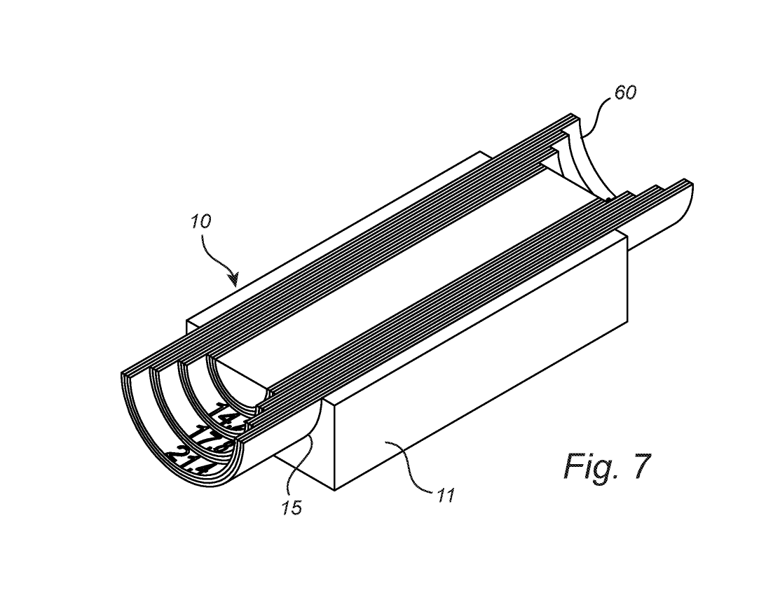

In FIGS. 5 and 6 the peelable layers have a slightly different design. All layers 40, 50 have a length exceeding the longitudinal length of the groove in the body to provide the desired good grip described above. In order to further facilitate the gripping and the selection of the desired layers, the layers in the stack have different length. The length of the layers increases higher up in the stack of layers 40, 50 to extend further outside the body and the layers underneath. The fact that the layers higher up in the stack extends further more clearly display the different layers for the installation engineer. In FIG. 3, the lengths are increasing for each layer 40 in the stack, while the length is increased stepwise in FIG. 4 such that two to four layers 50 will have the same length.

In FIG. 7 the design of the peelable layers are slightly modified. The general idée behind these embodiments is the same as the one described above, i.e. facilitate the gripping and the selection of the desired layers. Also in these embodiments the layers have different lengths exceeding the longitudinal length of the body. However, the length of the layers decreases higher up in the stack to extend less far outside the body and the layers underneath. The fact that the layers higher up in the stack extend less far more clearly displays the different layers for the installation engineer. In FIG. 7, the lengths of the layers 60 are reduced stepwise but the length could also be reduced for each layer higher up in the stack.

In order to further facilitate the removal of the right layers each layer is preferably marked with a numerical marking corresponding to the intended cable, wire or pipe diameter for the different layers. The marking is preferably located in the section of the layers extending outside the body to be easily detectable for the installation engineer during installation as well as at future inspections to verify that the installation are done correctly. Marking could also be arranged in on the layers in the area within the groove of the body to display additional information regarding the layer. The marking could be done in different ways, for example by printing symbols or numerical values on the surface of the layers, by laser engraving the desired symbols or numerical values alternatively the layers are casted in a mould with the symbols or values included in the mould to appear on the casted layers.

For all the illustrated embodiments it is preferable that the layer at least in a part of the overlapping area within the groove adhere to each other and the groove to remain in the intended position in the groove. This could be achieved by adapting the surface characteristics of selected areas of the groove and layers, or by applying an adhesive coating between adjacent layers. However, the sections of the layers extending outside the body should not adhere to each other to facilitate the selection of the layers that should be removed.

For all the illustrated embodiments it is preferable that the layer in the stack have different colours to make it easier to distinguish the different layers. Depending on the number of layers in the stack each layer cold be provided with a specific unique colour, alternatively a limited number of colours are repeated in a predetermined sequence to achieve the visual contrast between adjacent layers without using so many different colours.

If there are no cables, wires or pipes remaining within the frame, the insert block half could be sealed by a semi-cylindrical insert adapted to the radius of the peelable layer in the top of the stack of layers. When the insert half should be fitted around the cable, wire or pipe, the insert is removed together with the desired number of layers to open the passage.

All the described embodiments intend to provide flexible insert block halves that facilitate the fitting of the insert blocks halve on the cable, wire or pipe as well as the installation for the installation engineer without requiring an insert bock halve that is complex and in the end extremely expensive to manufacture. This is achieved by the present invention since all embodiments of the peelable layers only involves layers with a constant curved cross-sectional shape that makes them possible to manufacture in an efficient way. The extended layers according to the invention furthermore provides a very god grip for the operators fingers which is favourable during removal of selected layers, and provides an excellent position for numerical marking of the intended fitting diameter for each layer.

In order to further reduce the risk leakage via the passage for the cable, wire or pipe a measuring device developed to be used in combination with the insert block halves described above. A particular measuring device is intended to be delivered together with insert block halves corresponding to that particular measuring device and comprises an elongated flexible strip with a length exceeding the circumference of passage formed by the groove in the two insert halves forming the insert block intended to be fitted around a cable, wire or pipe. The strip is provided with a scale corresponding to the thickness of the layers and the installation engineer put the elongated strip around the cable, wire or pipe and uses the scale to determine the number and/or colour of the layer corresponding to the diameter of the present cable, wire or pipe. Once the number or diameter of the cable, wire or pipe is established the correct number of layers could be pealed of and the insert block halves fitted around the cable, wire or pipe.

Furthermore, the embodiments described above could all be combined and modified in different ways without departing from the scope of the invention that is defined by the appended claims.

1. Insert block half for sealing around a cable, pipe or wire, said insert block half comprising:
a body with a first and a second end, a first side intended to be arranged towards a substantially identical insert block half, and a semi-circular groove arranged in said first side and extending between the first and second end:
a number of peelable layers arranged in the groove, each layer having a shape corresponding to the shape of the semi-cylindrical groove to fit within the groove, and a length exceeding the length between the first and second end of the body.

2. The insert block half according to claim 1, wherein the layers adhere to adjacent layer or groove at least partially in the area between the first and second end of the insert block half, and not adhere to each other i the area extending outside the groove of the insert block half.

3. The insert block half according to claim 2, wherein the adhering is achieved by a coating applied between the layers or groove.

4. The insert block half according to claim 1, wherein the part of the layers extending outside the body is intended to enclose the cable, pipe or wire.

5. The insert block half according to claim 1, wherein numerical values or symbols corresponding to the radius of the passage formed by each layer are arranged on the part of the layers arranged outside the body.

6. The insert block half according to claim 1, wherein adjacent layers in the groove of the body have different colours.

7. The insert block half according to claim 2, wherein the layers in the groove have substantially the same length and extend 5 to 30 mm outside the respective first and/or second end of the body.

8. The insert block half according to claim 7, wherein at least some of the layers in the groove have different length.

9. The insert block half according to claim 7, wherein the length of the layers are changed stepwise such that at least two adjacent layer have the same length.

10. The insert block half according to claim 7, wherein the layer adjacent to the groove in the body is the shortest one and the length of the layers increase towards the top layer of the insert block half.

11. The insert block half according to claim 7, wherein the layer (60) adjacent to the groove in the body is the longest one and the length of the layers decreased towards the top layer of the insert block half.

12. Insert block for sealing around a cable, pipe or wire comprising two insert block halves according to claim 2, said insert halves are arranged with the grooves facing each other such that a passage is formed through the insert block.

13. Use of a number of insert blocks according to claim 12 in a metal frame fitted in a partition wall for sealing of at least one cable, pipe or wire extending through said partition wall.
